(19) United States
(12) Patent Application Publication
(10) Pub. No.: US 2009/0298691 A1
(43) Pub. Date: Dec. 3, 2009

(54) METHODS AND COMPOSITIONS FOR CONTROL OF AQUATIC WEEDS USING HERBICIDAL COMBINATIONS WITH FLURIDONE

(76) Inventors: Tyler J. Koschnick, Medina, OH (US); Mark A. Heilman, Rocky Mount, NC (US); Steve D. Cockreham, Indianapolis, IN (US); David P. Tarver, Tallahassee, FL (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 12/429,704

(22) Filed: Apr. 24, 2009

Related U.S. Application Data
(60) Provisional application No. 61/048,068, filed on Apr. 25, 2008.

(51) Int. Cl. A01N 59/20; A01N 43/90; A01N 43/40

(52) U.S. Cl. 504/121; 504/136; 504/130

(57) ABSTRACT

Described are preferred methods and compositions for controlling aquatic weeds that involve the use of fluridone in combination with at least one additional selected herbicidal agent, which is preferably penoxsulam, bensulfuron-methyl, bispyribac-sodium, and imazamox (ALS inhibitors). Additional preferred compositions and methods can further involve the use of triclopyr or 2,4-d (auxinic herbicides) in the herbicidal composition. Preferred herbicidal combinations allow for enhanced control and/or selectivity when treating a body of water to control a target weed population, such as a hydrilla, watermilfoil, curlyleaf pondweed, and/or Brazilian elodea weed populations.

### REFERENCE TO RELATED APPLICATION

The present application claims the benefit of U.S. Provisional Patent Application No. 61/048,068 filed Apr. 25, 2008, entitled METHODS AND COMPOSITIONS FOR CONTROL OF AQUATIC WEEDS USING HERBICIDAL COMBINATIONS WITH FLURIDONE, which is hereby incorporated herein by reference.

### BACKGROUND

The present invention related generally to methods and compositions for controlling aquatic weeds, and certain particular embodiments, methods and compositions for selectively controlling hydrilla, watermilfoil, curlyleaf pondweed, and/or Brazilian elodea utilizing a combination of fluridone and at least one additional herbicidal agent.

As further background, aquatic plants very commonly arise as undesired weeds in waters and wetlands in the United States of America and elsewhere. Three such exotic weeds are hydrilla, curlyleaf pondweed, and watermilfoil, including Eurasian watermilfoil, which present problems in ponds, lakes, and other water bodies. The treatment of such bodies of water to eliminate or control the undesired or exotic aquatic weeds is often complicated by the fact that the agent used to control the undesired weed also detrimentally affects the health of other, desirable or native plant life within the water body. Aquatic herbicides need to be in contact with aquatic or submersed aquatic plants for a period of time (exposure time), which is dependent on the individual agent and the concentration at which it is used. Specific herbicides can require long exposures (months) to control certain plants in water, which can also cause increased detriment to non-target species. Long exposures can be difficult to maintain in a fluid environment. Insufficient exposure can lead to poor efficacy or failed treatments. Thus, methods or techniques to reduce exposure times and/or reduce the concentrations of agents used to control submersed weeds could benefit efficacy and/or selectivity. Also, relying on a single herbicide mode of action can enhance the risk of selecting a resistant plant biotype to that particular agent. Thus, treatment regimens that are more selective for the undesired plant species, minimize potential for resistance development, and/or reduce exposure times are needed.

The efficacy of herbicidal agents against the target aquatic weeds depends on several factors, including the application dose, the specific formulation, the plant type, climatic conditions, water and sediment conditions in the water body, herbicide exposure time, and the like. At times, an inability to control an undesired weed can be eliminated simply by increasing the rate of application or concentration for a particular herbicidal agent. However, this is not always the case, and higher rates of application can exacerbate undesired affects on beneficial plants and aquatic organisms, and may not adequately compensate for insufficient exposure with the targeted plant.

One possible way to improve aquatic weed control is to combine two or more active compounds in the treatment. However, the use of two or more active compounds often fails due to physical or biological incompatibility, lack of stability in co-formulation, decomposition of the compounds, antagonistic effects between the compounds, costs, and/or other factors.

In view of the background in aquatic weed control, the discovery of enhanced or alternative methods and compositions for the control of aquatic weeds has been a difficult endeavor. Serious needs thus remain.

### SUMMARY

In certain aspects of the invention, it has been discovered that combinations of selected herbicidal agents are unexpectedly effective when applied to aquatic plants, and/or can be used to improve selectivity for target aquatic weeds, thus having a lesser effect on non-target plant species due to reduced concentration of or exposure to the herbicidal agents.

In certain specific embodiments, aquatic weeds, for example hydrilla, curlyleaf pondweed, and watermilfoil, can be effectively controlled by combinations of fluridone with at least one additional selected herbicidal agent, preferably an ALS inhibitor herbicidal agent such as penoxsulam. Additionally, it has been discovered that treatments using such herbicidal combinations can be further enhanced by the addition of a synthetic auxinic herbicidal agent such as triclopyr and/or 2,4-d. Aspects of the present invention therefore relate to methods for treating water bodies to control undesired aquatic weeds with combinations of these active agents with fluridone, to compositions including such combinations, and to methods for preparing herbicidal combination compositions which involve mixing such combinations of active agents. Still further inventive embodiments, as well as features and advantages thereof, will be apparent from the descriptions herein.

### BRIEF DESCRIPTION OF THE DRAWINGS

FIG. 1 displays the fluridone (F) and penoxsulam (P) impact on hydrilla stem length (top) and biomass (bottom) when applied alone at 12 ppb, and in combination at a total of 6 and 12 ppb on two biotypes of hydrilla.

FIG. 2 displays the results for fluridone (F) and penoxsulam (P) impact on hydrilla biomass when applied alone at 6 and 12 ppb and in combination at 12 ppb on three biotypes of hydrilla.

FIG. 3 displays the fluridone (F) and penoxsulam (P) impact on hydrilla biomass when applied alone (F and P at 3 and 6 ppb) and in combination at a total of 6 ppb on two biotypes of hydrilla.

FIG. 4 displays the hydrilla net photosynthesis (PHS) following 14-day of exposure to fluridone (F) and penoxsulam (P) applied alone (S and P at 3 and 6 ppb) and in combination at a total of 6 ppb on two biotypes of hydrilla (fluridone susceptible and fluridone resistant).

FIG. 5 diaplays chlorophyll a content in hydrilla apical sections exposed to fluridone (F) and penoxsulam (P) applied alone at 1 ppb and in combination at 2 ppb (1:1 ratio; 1+1 ppb) on fluridone susceptible hydrilla.

FIG. 6 displays the root and shoot dry weights of Eurasian watermilfoil following a 40 day exposure to 75 ppb triclopyr (T75), 5 ppb fluridone (F5) and 2 ppb penoxsulam (P2) alone, and in combination at 82 ppb.

FIG. 7 displays the mean hydrilla biomass in a lake in Orange County, Florida treated with a combination of fluridone (0.01 ppm) and endothall (0.71 ppm a.e.) on 27 Feb. 2009.

FIG. 8 displays the non-linear regression analysis for fluridone+penoxsulam 1:1 combination, fluridone alone, and penoxsulam alone on shoot biomass of seven aquatic plant species.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

As discussed above, aspects of the present invention relates to methods and compositions involving the use of fluridone in combination with certain other types of herbicidal agents for controlling aquatic weeds, and especially hydrilla, curlyleaf pondweed, and watermilfoil. In preferred inventive aspects, fluridone is combined with an ALS inhibitor herbicide and optionally also an auxinic herbicide (e.g. 2,4-d or triclopyr). Such combinations desirably: enable the use of lower levels of each herbicidal agent as compared to that which would have to be used with each agent individually; enable the use of sub-lethal levels of each herbicidal agent (if used individually); enable a reduction in the total amount of herbicide needed for control (reducing water use restriction); enable a reduction in the total exposure time needed for control; exhibit an activity that is greater than the individual agents when used alone, more desirably a synergistic or at least additive effect; enhance the level of control for the target aquatic weed population; and/or enhance the selectivity for the target aquatic weed population. As well, the use of such herbicidal agent combinations may enhance the treatment of aquatic weed biotypes that have developed resistance to at least one of the agents included, and may benefit long term weed control by inhibiting the development of additional resistant biotypes. Using tank mixes of herbicidal agents or otherwise applying herbicides with multiple modes of action can also provide a means of proactive resistance management. Dual agents reduce the chance for selecting a biotype that is resistant under simultaneous exposure, as the biotype would have to confer resistance to both modes of action.

The chemical fluridone (1-methyl-3-phenyl-5-3-(trifluoromethyl)phenyl-4(1H)-pyridinone) is a known herbicide for use in the control of aquatic weeds. Fluridone is sold under the trade name SONAR®, available from SePRO Corporation, Carmel, Ind., in either liquid or pelleted (on clay) formulations. Fluridone is a systemic herbicide that is absorbed from water by plant shoots and from hydrosoil by roots. It inhibits carotenoid synthesis which in turn enhances the degradation of chlorophyll. This produces a characteristic bleached appearance to susceptible plants.

Acetolactate synthase (ALS) or acetohydroxy acid synthase (AHAS) inhibitors represent another class of herbicidal agents. These agents inhibit the acetolactate synthase enzyme, which leads to the depletion of key amino acids that are necessary for protein synthesis and plant growth. The following herbicidal agents belong to this class:

| Common Name | Chemical Name |
|---|---|
| Penoxsulam | 2-(2,2-difluoroethoxy)-6-trifluoromethyl-N-(5,8- |
| | dimethoxy[1,2,4]triazolo[1,5c]pyrimidin-2- |
| | yl)benzenesulfonamide) |
| Bensulfuron- | 2-((((((4,6-Dimethoxy-2- |
| methyl | pyrimidinyl)amino)carbonyl)amino)sulfonyl)meth- |
| | yl)benzoic acid, ethyl ester |
| Bispyribac- | Benzoic acid, 2,6-bisõ(4,6-dimethoxy-2- |
| sodium | pyrimidinyl)oxy-sodium salt |
| Imazamox | 2-[4,5-dihydro-4-methyl-4-(1-methylethyl)-5- |
| | oxo-1H-imidazol-2-yl]-5-(methoxymethyl)-3- |
| | pyridinecarboxylic acid |

It will be understood that herbicidal compounds such as those identified herein by common name are often available as a parent compound or as an herbicidally active derivative such as a salt or ester. Accordingly, all such herbicidally active derivatives are intended to be encompassed by use of the common name for the chemical, unless otherwise specified.

In accordance with certain embodiments of the invention, methods for the control of hydrilla, Eurasian watermilfoil or other undesirable aquatic weeds include the application of a combination of fluridone with at least one member selected from the group consisting of penoxsulam, bensulfuron-methyl, bispyribac-sodium, and imazamox. As to amounts, these agents will be included in a combination that is effective to achieve control of the aquatic weed in question. Typically, such amounts will be in the range of about 1 to 200 ppb, more typically 1 to about 100 parts per billon (ppb), more typically in the range of about 2.5 to about 50 ppb, and more specifically in the range of 5 to 25 ppb, for each of the active agents included in the combination. Such amounts would typically range in a mass ratio of about 25:1 to 1:25, more typically 10:1 to 1:10, more specifically 8:1 to 1:8. It has been discovered that such herbicidal combinations can be used together without having the herbicidal agents antagonize one another.

In embodiments in which fluridone is used in combination with penoxsulam, the fluridone will desirably be used at a level in the range of about 2 to about 20 ppb and the penoxsulam at a level in the range of about 2 to about 80 ppb and more preferably for the penoxsulam at a level in the range of about 2 to about 20 ppb. As well, in these or other embodiments, the fluridone and penoxsulam will desirably be used in a mass ratio of about 1:4 to about 4:1.

In embodiments in which fluridone is used in combination with bensulfuron-methyl, the fluridone will desirably be used at a level in the range of about 2 to about 20 ppb and the bensulfuron-methyl at a level in the range of about 4 to about 160 ppb and more preferably for the bensulfuron-methyl at a level in the range of about 4 to about 40 ppb. As well, in these or other embodiments, the fluridone and bensulfuron-methyl will desirably be used in mass ratio of about 1:8 to about 8:1.

In embodiments in which fluridone is used in combination with bispyribac-sodium, the fluridone will desirably be used at a level in the range of about 2 to about 20 ppb and the bispyribac-sodium at a level in the range of about about 4 to about 160 ppb and more preferably for the bispyribac-sodium at a level in the range of about 4 to about 40 ppb. As well, in these or other embodiments, the fluridone and bispyribac-sodium will desirably be used in a mass ratio of about 1:8 to about 8:1.

In embodiments in which fluridone is used in combination with imazamox, the fluridone will desirably be used at a level in the range of about 2 to about 20 ppb and the imazamox at a level in the range of about 10 to about 200 ppb and more preferably for the imazamox in the range of about 50 to about 200 ppb. As well, in these or other embodiments, the fluridone and imazamox will desirably be used in a mass ratio of about 1:2 to about 1:40, more typically about 1:5 to about 1:40.

With respect to the levels and mass ratios of herbicidal agents stated above or elsewhere herein, it will be understood that not all aspects of the invention are limited to the stated levels or ratios, and that different amounts or ratios may be used in other embodiments, depending upon the plant management objectives, the target species, or other factors.

As disclosed above, in additional aspects of the invention, the combination of agents may include at least a third herbicidal agent selected from auxinic herbicidal agents such as triclopyr (3,5,6-trichloro-2-pyridyloxyacetic acid or herbicidally active salts or esters thereof, including a triethylamine salt or butoxyethyl ester) or 2,4-d ((2,4-dichlorophenoxy) acetic acid or herbicidally active salts or esters thereof, including a dimethylamine or sodium salt and butoxyethyl ester) or alternatively quinclorac (3,7-dichloro-8-quinolinecarboxylic acid), aminopyralid (4-amino-3,6-dichloro-2-pyridinecarboxylic acid), or fluroxypyr ([(4-amino-3,5-dichloro-6-fluoro-pyridinyl)oxy]acetic acid). Thus, herbicidal compositions comprising at least a ternary mixture of herbicidal agents including fluridone, an ALS inhibitor as noted above, and at least one of triclopyr and 2,4-d, or another agent as identified above, are also provided in accordance with the invention.

In embodiments in which fluridone is used in combination with penoxsulam and triclopyr, the fluridone will desirably be used at a level in the range of about 2 to about 10 ppb, the penoxsulam at a level in the range of about 2 to about 20 ppb and more preferably about 2 to about 10 ppb, and the triclopyr at a level of about 50 to about 500 ppb. As well, in these or other embodiments, the fluridone, penoxsulam and triclopyr will desirably be used in a respective mass ratio of about 1:4:100 to about 4:1:100.

In embodiments in which fluridone is used in combination with penoxsulam and 2,4-d, the fluridone will desirably be used at a level in the range of about 2 to about 10 ppb, the penoxsulam at a level in the range of about 20 to about 20 ppb and more preferably about 2 to about 10 ppb, and the 2,4-d at a level of about 100 to about 1000 ppb. As well, in these or other embodiments, the fluridone, penoxsulam and 2,4-d will desirably be used in a respective mass ratio of about 1:4:200 to about or 4:1:200.

In embodiments in which fluridone is used in combination with bensulfuron-methyl and triclopyr, the fluridone will desirably be used at a level in the range of about 2 to about 10 ppb, the bensulfuron-methyl at a level in the range of about 2 to about 80 ppb and more preferably about 2 to about 40 ppb, and the triclopyr at a level of about 50 to about 500 ppb. As well, in these or other embodiments, the fluridone, bensulfuron-methyl and triclopyr will desirably be used in a respective mass ratio of about 1:6:100 to about 6:1:100.

In embodiments in which fluridone is used in combination with bensulfuron-methyl and 2,4-d, the fluridone will desirably be used at a level in the range of about 2 to about 10 ppb, the bensulfuron-methyl at a level in the range of about 2 to about 80 ppb and more preferably about 2 to about 40 ppb, and the 2,4-d at a level of about 100 to about 1000 ppb. As well, in these or other embodiments, the fluridone, bensulfuron-methyl and 2,4-d will desirably be used in a respective mass ratio of about 1:6:200 to about 6:1:200.

In embodiments in which fluridone is used in combination with bispyribac-sodium and triclopyr, the fluridone will desirably be used at a level in the range of about 2 to about 10 ppb, the bispyribac-sodium at a level in the range of about 2 to about 80 ppb and more preferably about 2 to about 40 ppb, and the triclopyr at a level of about 50 to about 500 ppb. As well, in these or other embodiments, the fluridone, bispyribac-sodium and triclopyr will desirably be used in a respective mass ratio of about 1:6:100 to about 6:1:100.

In embodiments in which fluridone is used in combination with bispyribac-sodium and 2,4-d, the fluridone will desirably be used at a level in the range of about 2 to about 10 ppb, the bispyribac-sodium at a level in the range of about 2 to about 80 ppb and more preferably about 2 to about 40 ppb, and the 2,4-d at a level of about 100 to about 1000 ppb. As well, in these or other embodiments, the fluridone, bispyribac-sodium and 2,4-d will desirably be used in a respective mass ratio of about 1:6:200 to about 6:1:200.

In embodiments in which fluridone is used in combination with imazamox and triclopyr, the fluridone will desirably be used at a level in the range of about 2 to about 10 ppb, the imazamox at a level in the range of about 25 to about 200 ppb and more preferably about 50 to about 200 ppb, and the triclopyr at a level of about 50 to about 500 ppb. As well, in these or other embodiments, the fluridone, imazamox and triclopyr will desirably be used in a respective mass ratio of about 1:2:10 to about 1:25:100, more typically about 1:5:10 to about 1:25:100.

In embodiments in which fluridone is used in combination with imazamox and 2,4-d, the fluridone will desirably be used at a level in the range of about 2 to about 10 ppb, the imazamox at a level in the range of about 25 to about 200 ppb and more preferably about 50 to about 200 ppb, and the 2,4-d at a level of about 100 to about 1000 ppb. As well, in these or other embodiments, the fluridone, imazamox and 2,4-d will desirably be used in a respective mass ratio of about 1:2:20 to about 1:25:200, more typically about 1:5:20 to about 1:25:200.

In additional embodiments of the invention, one or more other selected herbicidal agents can be used in combination instead of or in addition to either or both the ALS inhibitor or the synthetic auxin herbicide as discussed above. In these aspects, the combination of agents can include fluridone and a PPO-inhibitor herbicide, a photosynthetic inhibitor herbicide, a membrane disruptor herbicide, or another carotenoid biosynthesis inhibitor herbicide to control aquatic weeds.

Protoporphyrinogen oxidase inhibitors (PPO, Protox, or PPG oxidase inhibitors) are another herbicidal agent that can be applied with fluridone. These inhibit the protoporphyrinogen oxidase enzyme in the chlorophyll biosynthesis pathway, ultimately resulting in cell membrane leakage. Fluridone inhibits the production of carotenoids, which protect chlorophyll from photodegradation; in combination with PPO inhibitors that inhibits the production of chlorophyll; thus resulting in two agents impacting chlorophyll in plants. The following herbicidal agents belong to this class:

| Common Name | Chemical Name |
|---|---|
| Carfentrazone- | ethyl α,2-dichloro-5-[4-(difluoromethyl)-4,5-dihydro- |
| ethyl | 3-methyl-5-oxo-1H-1,2,4-triazol-1-yl]-4- |
| | fluorobenzenepropanoate |
| Flumioxazin | 2-[7-fluoro-3,4-dihydro-3-oxo-4-(2-propynyl)-2H-1,4- |
| | benzoxazin-6-yl]-4,5,6,7-tetrahydro-1H-isoindole- |
| | 1,3(2H)-dione |

In embodiments in which fluridone is used in combination with carfentrazone, such as carfentrazone-ethyl, the fluridone will desirably be used at a level in the range of about 2 to about 20 ppb and the carfentrazone at a level in the range of about 50 to about 200 ppb. As well, in these or other embodiments, the fluridone and carfentrazone will desirably be used in a mass ratio of about 1:5 to about 1:50.

In embodiments in which fluridone is used in combination with flumioxazin, the fluridone will desirably be used at a level in the range of about 2 to about 20 ppb and the flumioxazin at a level in the range of about 50 to about 200 ppb. As well, in these or other embodiments, the fluridone and flumioxazin will desirably be used in a mass ratio of about 1:5 to about 1:50.

Membrane disrupting herbicides effect cell integrity and uncouple membrane transport mechanisms resulting in cell degradation. Both endothall and copper can be classified as membrane disruptors, although their exact mode of action is unclassified. These agents could alter herbicide uptake. The following herbicidal agents belong to this class:

| Common Name | Chemical Name |
|---|---|
| Endothall | 7-oxabicyclo[2.2.1]heptane-2,3-dicarboxylic acid |
| Copper | elemental copper |

In embodiments in which fluridone is used in combination with endothall, the fluridone will desirably be used at a level in the range of about 2 to about 20 ppb and the endothall at a level in the range of about 150 to about 3000 ppb a.e. (acid equivalence or a.e.). As well, in these or other embodiments, the fluridone and endothall will desirably be used in a mass ratio of about 1:50 to about 1:500.

In embodiments in which fluridone is used in combination with copper, the fluridone will desirably be used at a level in the range of about 2 to about 20 ppb and the copper at a level in the range of about 100 to about 500 ppb. As well, in these or other embodiments, the fluridone and copper will desirably be used in a mass ratio of about 1:10 to about 1:125.

Diquat (6,7-dihydrodipyrid[1,2-a:2′,1′-c]pyrazinedium) is a photosynthetic inhibitor diverting electron flow in photosystem I of photosynthetic electron transport, ultimately resulting in radical oxygen production and cell membrane degradation. In embodiments in which fluridone is used in combination with diquat, the fluridone will desirably be used at a level in the range of about 2 to about 20 ppb and the diquat at a level in the range of about 100 to about 300 ppb. As well, in these or other embodiments, the fluridone and diquat will desirably be used in a mass ratio of about 1:20 to about 1:75.

Although fluridone is a carotenoid biosynthesis inhibitor (CBI), other CBI applied in combination with fluridone may target different sites of action in the same pathway. CBI inhibit the formation of carotenoids in plants by targeting specific enzymes such as: the phytoene desaturase enzyme (PDS-inhibitors=fluridone) or 4-hydroxyphenyl-pyruvate dioxygenase (4-HPPD-inhibitors=mesotrione). The following herbicidal agents belong to this class:

| Common Name | Chemical Name |
|---|---|
| Topramezone | [3-(4,5-dihydro-3-isoxazolyl)-2-methyl-4- |
| | (methylsulfonyl)phenyl](5-hydroxy-1-methyl-1H- |
| | pyrazol-4-yl)methanone |
| Mesotrione | 2-[4-(methysulfonyl)-2-nitrobenzoyl]-1,3- |
| | cyclohexanedione |

In embodiments in which fluridone is used in combination with topramezone, the fluridone will desirably be used at a level in the range of about 2 to about 20 ppb and the topramezone at a level in the range of about 5 to about 500 ppb and more preferably about 10 to about 200 ppb. As well, in these or other embodiments, the fluridone and topramezone will desirably be used in a mass ratio of about 50:1 to about 1:50.

In embodiments in which fluridone is used in combination with mesotrione, the fluridone will desirably be used at a level in the range of about 2 to about 20 ppb and the mesotrione at a level in the range of about 5 to about 500 ppb and more preferably about 10 to about 100 ppb. As well, in these or other embodiments, the fluridone and mesotrione will desirably be used in a mass ratio of about 25:1 to about 1:25.

Methods and compositions of the invention may be used in the complete or partial control of many noxious plants. These include, for example, common duckweed (Lemna minor), of the emersed plants spatterdock (Nuphar luteum) and water-lily (Nymphaea spp.), of the submersed plants bladderwart (Utricularia spp.), common coontail (Ceratophyllum demersum), common elodea (Elodea canadensis), Brazilian elodea (Egeria densa), fanwort (Cabomba caroliniana), hydrilla (Hydrilla verticillata), naiad (Najas spp.), pondweed (Potamogeton spp.) and more specifically curlyleaf pondweed (Potamogeton crispus), watermilfoil (Myriophyllum spp.) including Eurasian watermilfoil, floating plants including common watermeal (Woffia columbiana) and salvinia (Salvinia spp.), emersed plants including alligatorweed (Alternanthera philoxeroides), American lotus (Nelumbo lutea), cattail (Typha spp.), creeping waterprimrose (Ludwigia peploides), parrotfeather (Myriophyllum aquaticum), smartweed (Polygonaum spp.), spikerush (Eleocharis spp.), waterpurslane (Ludwigia palustris), and watershield (Brasenia schreberi), of the submersed plants Illinois pondweed (Potamogeton illinoensis), limnophila (Limnophila sessiliflora), tapegrass or American eelgrass (Vallisneria americana), and variable leaf watermilfoil (Myriophyllum heterophyllum), and the shoreline grasses barnyardgrass (Echinochloa crusgalli), and southern watergrass (Hydrochloa caroliniensis). Particularly preferred plant types for control in accordance with the invention include hydrilla, watermilfoil, curlyleaf pondweed, and Brazilian elodea.

For use together, it is not necessary that the two or more herbicides be applied in a physically combined form, or even at the same time. The combination effect results so long as the two or more herbicides are present in the body of water at the same time, regardless of when they were applied. Thus, for instance a physical combination of the two or more herbicides could be applied, or one or some could be applied earlier than the other(s). Typically, however, the herbicides will be applied within 1 to 7 days of each other. Further, in certain embodiments the herbicides can be applied within about 90 days or less of each other, or within about 30 days or less of each other, in which case the herbicides may or may not be present in the body of water at the same time. For example, one agent can be applied in the presence of or following an exposure to the other agent, for example to reduce exposure time, inhibit potential for plant recovery, or enhance efficacy or selectivity. Thus, one herbicidal agent may or may not be present for the duration based on chemical half-lives in water or can be added to the other agent or after the other agent was in the presence of the target plant or vice versa. In preferred forms in which the herbicides are not present in the body of water at the same time, the second or following sequentially applied herbicide will nonetheless be applied at a time at which the target plants are still exhibiting an effect from the prior-applied herbicide, in which cases the prior herbicide may have been applied at lethal, or at sub-lethal doses. Symptoms of such continuing stress from the prior applied herbicide will depend upon the particular plant species and/or particular herbicide involved and will be determinable by those skilled in the field, but may for example include a reduced biomass or deterioration in health of the target plants as compared to the time at which the prior-applied herbicide was introduced into the body of water.

Any of the herbicides can thus be applied separately in liquid or solid form, or a combination product containing some or all herbicides could be produced, again, in either liquid or solid form. Typical liquid formulations include emulsions, suspensions (including suspensions containing microcapsules), solutions, emulsifiable concentrates, and flowables. Common solid forms include granules, wettable powders, water-dispersible solid (including water-dispersible granules containing microencapsulated pesticides) or dusts. The herbicidal formulation can also contain, in addition to the active herbicide(s) other ingredients such as solvents, wetting agents, suspending agents, anti-caking agents, dispersing agents, emulsifiers, antifreeze agents, antifoam agents, and other additives.

Compositions according to this invention may contain the two or more herbicides in numerous different physical forms. In some cases, a composition may be produced by simply physically mixing (“tank mixing”) commercially available products containing the active herbicides. Alternatively, a package may be manufactured and sold which contains the two or more herbicides in separate containers, but packaged together, e.g. in a “multi-pack” format such as a “twin-pack” or “tri-pack”.

Alternatively, previously prepared compositions (“premixes”) containing the two or more herbicides can be produced. Suitable liquid compositions would include solutions or emulsions containing the two or more herbicides. A solid product containing the two or more herbicides could also be produced, for instance, as impregnated granules.

The combination of herbicidal agents utilized should remain at herbicidally effective levels in the body of water in contact with the targeted plant to achieve control. Thus, in accordance with preferred methods of the invention, at least one of the herbicidal agents will be maintained in the treatment area or body of water under treatment for about 1 to 4 weeks, and in preferred embodiments for at least about four weeks, and typically in the range of about four to sixteen weeks or more. The other herbicidal agent or agents may or may not be present for the same duration, which can vary for example based on chemical half-lives of the agents in water, or can be added to the other agent already in the presence of the target plant or vice versa. The concentration of any single herbicidal agent or all agents in the combination may be maintained, when necessary, with the target plant to ensure efficacy, for example, through the use of sequential or bump treatments, or continuous injection, using the same agent.

Bodies of water to be treated with the inventive methods will typically be fresh water bodies such as ponds, lakes, wet lands, reservoirs, rivers or irrigation canals, although other bodies of water may also be treated in accordance with the invention.

In order to promote a further understanding of the present invention and its various embodiments, the following specific examples are provided. It will be understood that these examples are illustrative and not limiting of the invention.

### EXAMPLE 1

### Control of Hydrilla with Fluridone and Penoxsulam

### Materials and Methods

Apical sections of hydrilla were collected from Rainbow River and Lake Okahumpka, Fla. Hydrilla in Lake Okahumpka is known to have developed increased tolerance to fluridone (FRH). The biotype from Rainbow River has never been exposed to fluridone and is presumably fluridone susceptible. Apical sections were planted in potting soil amended with Osmocote fertilizer in small pots (13.5 cm length×3.75 cm diameter). A 2.54 cm sand layer was placed over the top of the potting soil. Pots containing each biotype of hydrilla were placed into 14 L acrylic cylinders and allowed to establish slight growth prior to treatment. Cylinders were then treated with penoxsulam (P) or fluridone (F) at 12 ppb, and fluridone+penoxsulam (1:1 ratio) at 6 ppb (3 ppb each) and 12 ppb (6 ppb each). All treatments were replicated 4 times. After 25 days of exposure, plants were harvested and total stem length and fresh weights were measured.

### Results

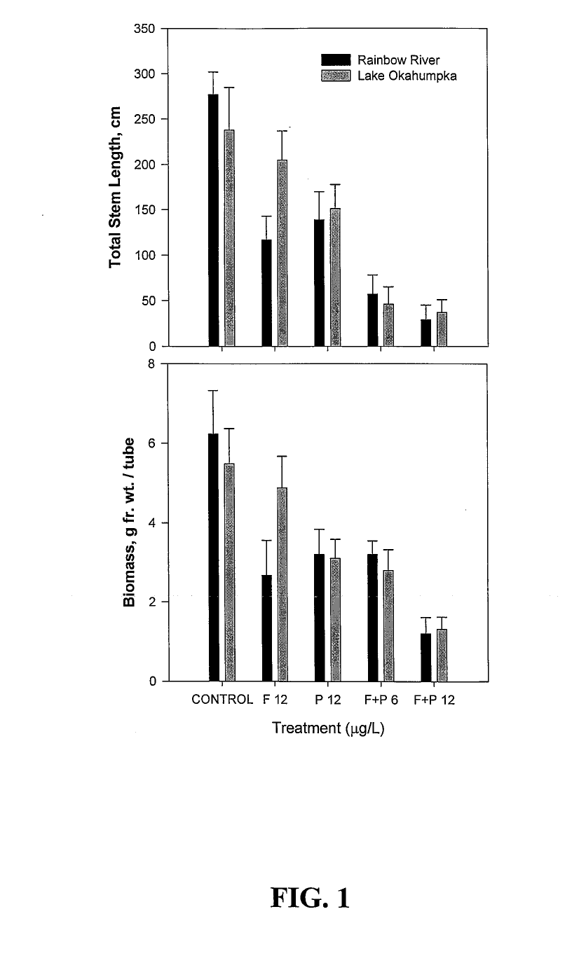

The results are summarized in FIG. 1, which reports total stem length and plant biomass. As shown, the combinations of fluridone and penoxsulam were surprisingly effective in the control of the hydrilla. Fluridone and penoxsulam in combination at 12 ppb provided significantly greater effect on hydrilla as compared to either agent when used alone at the same concentration. Fluridone plus penoxsulam was equally or more effective than either herbicide individually at concentrations equal to or 2 times the concentration used in combination. The combination of fluridone+penoxsulam at 12 ppb (6 ppb each) was effective on the fluridone tolerant biotype (Lake Okahumpka) whereas fluridone at 12 ppb had little effect; the combination had greater effect than 12 ppb of penoxsulam. This data suggest the combination of fluridone plus an ALS-inhibitor (penoxsulam) is synergistic; a ½× to 1× dose of the combination (1:1 ratio) provided equal to or greater effect than a 1× dose (12 ppb) of either alone.

Rainbow River hydrilla: stem length was inhibited compared to control plants by c.a. 80% with a combination totaling 6 ppb and c.a. 90% with a combination totaling 12 ppb; penoxsulam or fluridone at 12 ppb caused c.a. 50 to 60% reduction. Lake Okahumpka hydrilla: stem length was inhibited compared to control plants by c.a. 80% with a combination of fluridone and penoxsulam at 6 or 12 ppb; penoxsulam at 12 ppb caused a c.a. 40% reduction in length, and fluridone at 12 ppb caused a c.a. 10% reduction (fluridone resistant biotype).

When increased resistance or tolerance to fluridone was discovered in hydrilla, fluridone doses increased in aquatic plant control operations to control these biotypes. As fluridone concentrations increased, so did impact on some desirable species. Based on the results of this study: fluridone can be used effectively in combination with penoxsulam at relatively low doses to control populations of fluridone resistant hydrilla; effective fluridone concentrations are lower in combination with penoxsulam; effective penoxsulam doses are lower in combination with fluridone; the combination improves selectivity to non-target plants susceptible to either agent at higher doses (e.g. 12 ppb) by reducing the effective concentration of each.

Of particular note, efficacy from this combination was not expected, and was hypothesized to have antagonistic potential. Fluridone is more effective on rapidly growing plant tissue; the greatest enzyme turnover and thus bleaching effects are observed on apical meristems. Penoxsulam, in contrast, inherently inhibits plant growth due to the mode of action. It inhibits amino acid formation necessary for protein formation and turnover. Therefore, penoxsulam exposure could inhibit hydrilla growth causing fluridone to be less effective. This was not observed; in fact the two agents were surprisingly effective in combination.

### EXAMPLE 2

### Control of Hydrilla with Fluridone and Penoxsulam

### Materials and Methods

Hydrilla was collected from three sources in Florida; two representing fluridone resistant biotypes (Lake Okahumpka and Lake Cypress) and one fluridone susceptible biotypes (CAIP). Apical sections containing a single meristem were planted in small pots (13.5 cm length×3.75 cm diameter) containing potting soil and amended with Osmocote fertilizer. Each biotype were placed into 14 L cylinders and allowed to establish growth for 6-days prior to treatment. Treatments were replicated three times and included: controls, penoxsulam 6 and 12 ppb; fluridone 6 and 12 ppb; combinations of fluridone+penoxsulam (1:1 ratio) at 12 ppb (6 ppb each). Plants were exposed for c.a. 30 days and then harvested to determine plant weights.

### Results

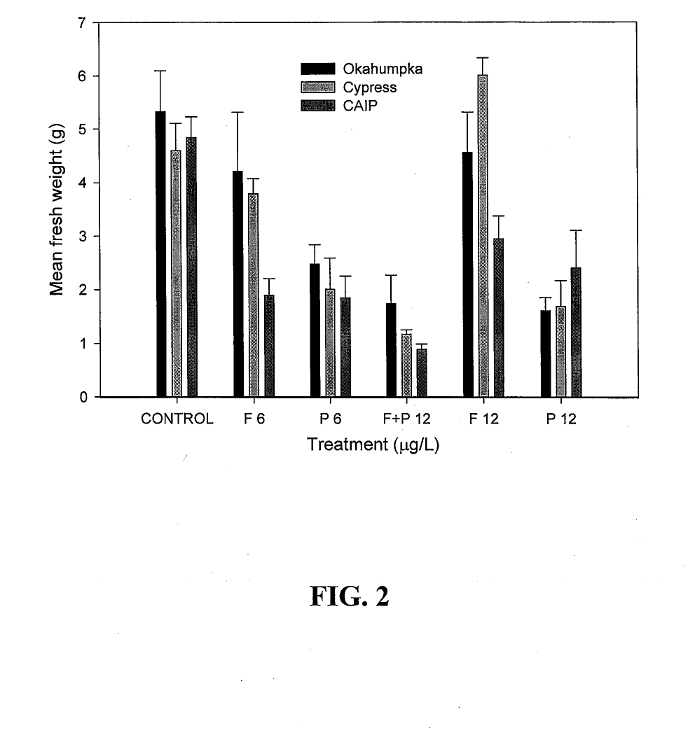

The results of this testing are summarized in FIG. 2. The fluridone and penoxsulam proved to be compatible when used in combination and demonstrated effective control of both the resistant and susceptible hydrilla. Biotypes resistant to fluridone (Cypress and Okahumpka) were generally not affected by fluridone up to 12 ppb. Fluridone+penoxsulam (12 ppb=6 ppb of each agent) surprisingly resulted in greater reductions in biomass than either agent at 6 ppb on all biotypes tested. Penoxsulam at 6 ppb resulted in a 53 (Okahumpka) and 57% (Cypress) biomass reduction on fluridone resistant biotypes and 63% reduction (CAIP) to fluridone susceptible hydrilla. Again, 6 ppb fluridone had minimal affect on fluridone resistant biotypes and 60% reduction on susceptible biotype; fluridone plus penoxsulam at 12 ppb increased control to 68% (Okahumpka), 74% (Cypress), and 81% (CAIP). The combination at 12 ppb had greater efficacy than fluridone at 12 ppb and similar or greater effect than penoxsulam at 12 ppb suggesting potential for synergistic activity.

### EXAMPLE 3

### Control of Hydrilla With Fluridone and Penoxsulam

### Materials and Methods

Hydrilla was collected from two sources in Florida representing a fluridone resistant biotype (Lake Cypress) and a fluridone susceptible biotype. Apical sections containing a single meristem were planted in small pots (13.5 cm length×3.75 cm diameter) containing potting soil and amended with Osmocote fertilizer. Each biotype were placed into 14 L cylinders and allowed to establish growth prior to treatment. Treatments were replicated three times and included: controls, penoxsulam or fluridone at 3 and 6 ppb; combinations of fluridone+penoxsulam (1:1 ratio) at 6 ppb (3 ppb of each). Plants were exposed for 56 days and then harvested to determine dry weights. At 14 days after treatment (DAT) net photosynthesis from exposed plant tissue was measured.

### Results

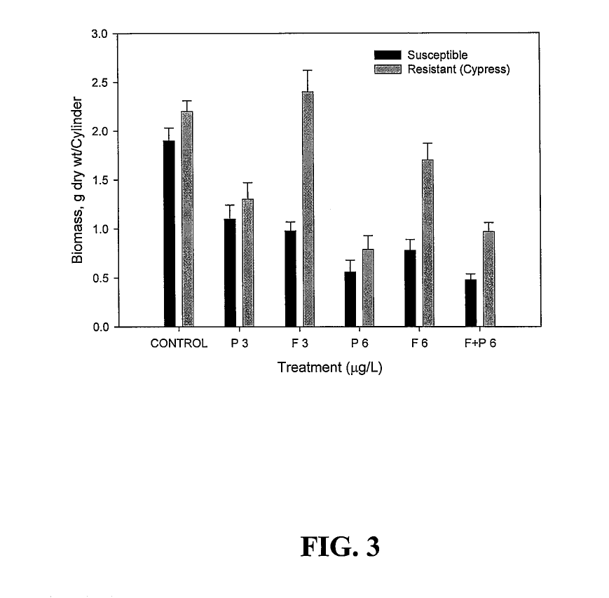

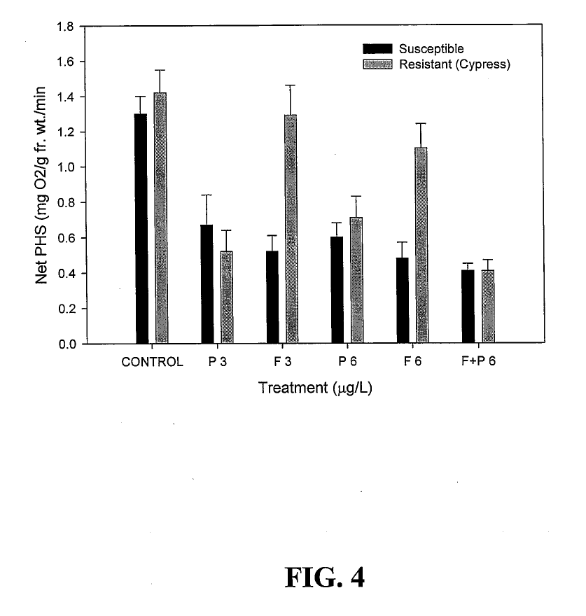

The results of this experimental are summarized in FIGS. 3 and 4. As shown, the fluridone and penoxsulam proved to be compatible when used in combination and demonstrated effective control of both the resistant and susceptible hydrilla. Surprisingly, combining fluridone with penoxsulam dramatically improved control even of fluridone-resistant hydrilla as compared to the use of penoxsulam alone. For example, penoxsulam at 3 ppb caused a c.a. 40% reduction in susceptible and resistant hydrilla biotype biomass. Fluridone at 3 ppb had no effect on the resistant biotype, but caused a c.a. 50% reduction in the susceptible biotype biomass compared to controls. When applied together at these concentrations (3 ppb+3 ppb), there was increased efficacy on the susceptible (c.a. 74%) and resistant biotype (c.a. 55%). The combination at 6 ppb was more effective than fluridone at 6 ppb, and similar to penoxsulam at 6 ppb based on biomass (FIG. 3). Net photosynthesis was inhibited more by the combination (6 ppb) than either herbicide alone (6 ppb).

### EXAMPLE 4

### Control of Hydrilla with Penoxsulam and Fluridone: Chlorophyll a Study

### Materials and Methods

Apical sections (c.a. 5 cm) of hydrilla were placed into 500 ml flasks containing a modified Hoagland's growth media (250 ml). Treatments were replicated four times and included: controls, penoxsulam or fluridone at 1 ppb; and a combination of fluridone+penoxsulam at 1+1 ppb. Plants were exposed in a growth chamber (27° C.; photoperiod 14/10) for 14 days and then harvested to determine chlorophyll a content.

### Results

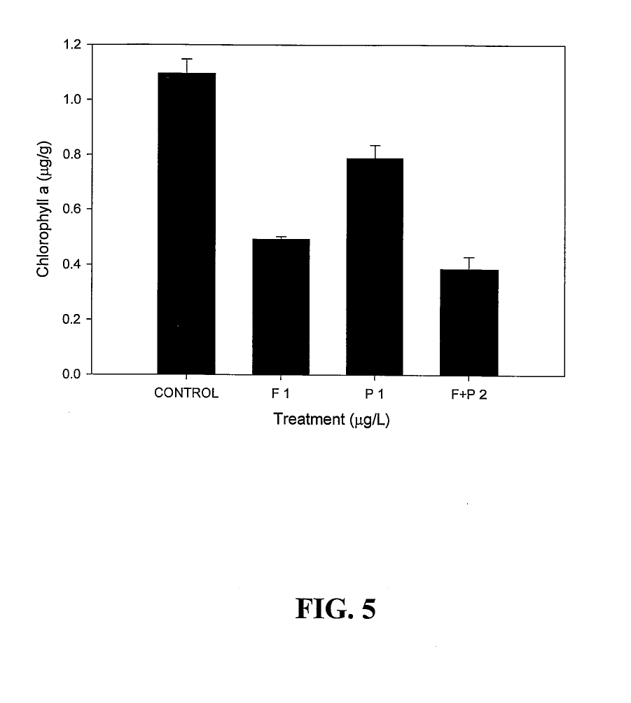

As shown in FIG. 5, the fluridone and penoxsulam proved to be compatible when used in combination and demonstrated effective control of the susceptible hydrilla even when used at very low levels. Compared to fluridone alone (1 ppb), chlorophyll was reduced when exposed to fluridone (1 ppb) in combination with penoxsulam (1 ppb). The mode of action of penoxsulam does not directly involve chlorophyll biosynthesis or degradation. Reduced chlorophyll levels when fluridone and penoxsulam were applied in combination may offer perspective on why the two agents have greater effect than when used singularly.

### EXAMPLE 5

### Control of Eurasian Watermilfoil with Fluridone, Penoxsulam and Triclopyr

### Materials and Methods

Apical sections (12 to 15 cm in length) of Eurasian watermilfoil (EWM) were taken from Sweetwater Lake, Ind. and from culture and planted into small pots (13.5 cm length×3.75 cm diameter) containing Wallace Farm® topsoil amended with 14-14-14 slow release Osmocote® fertilizer (˜2.5 g Osmocote/kg soil). Approximately 5 to 7 cm of the apical section extended above the sediment at planting, and a sand cap was placed over the potting soil (˜2 cm deep). Plants were then transferred to a 12 L acrylic tanks filled with well water. Plants were allowed to grow for 7 days before the following treatment was initiated in triple replicate:

### TREATMENTS

1) Untreated control

### 2) Triclopyr 75 ppb (T1)

### 3) Fluridone 5 ppb (F1)

### 4) Penoxsulam 2 ppb (P1)

### 5) T1+F1+P1

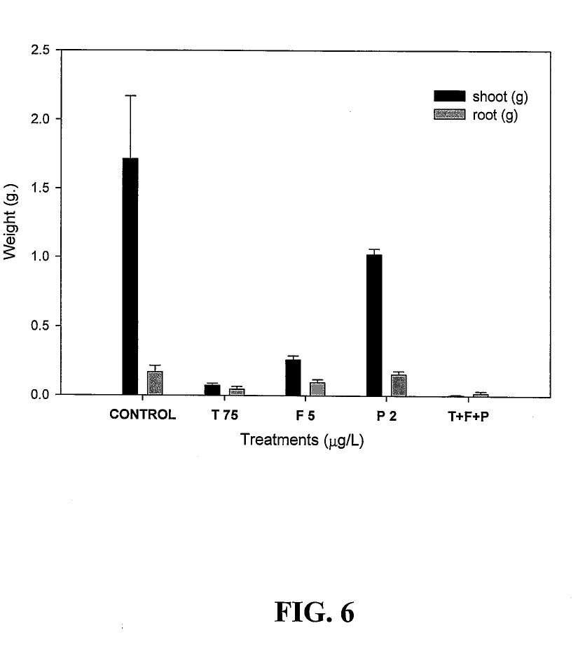

Plants were harvested at 40 days. At harvest, plants were rinsed free of algae, roots and shoots were separated, and placed in paper sacks in a drying oven for 4 days at 70° C. temperature, and dry weights were determined (FIG. 6).

### Results

The results of this experimental are summarized in FIG. 6. As shown, fluridone, penoxsulam and triclopyr proved to be compatible when used in combination, and together demonstrated an outstanding ability to control the watermilfoil. Root and shoot biomass was separated to evaluate a plants ability to recover or regrow from root stock following herbicide exposure. Triclopyr (75 ppb) reduced above ground biomass by 96%, but had less effect on below ground biomass (74% reduction) indicating potential for regrowth from these root stocks. Applied as a tertiary mix of fluridone (5 ppb)+triclopyr (75 ppb)+penoxsulam (2 ppb) resulted in a 89% reduction in root mass and a 99.8% reduction in shoot mass (98.9% total reduction). Therefore, the combination unexpectedly provided greater efficacy on total biomass, and more importantly, the below ground biomass thus limiting potential for regrowth. It was not anticipated that a combination of fluridone, penoxsulam, and triclopyr would increase efficacy. There was potential for antagonism between these herbicides: penoxsulam inhibits growth, triclopyr stimulates growth short-term whereas at sub-lethal concentrations could injure plants and reduce herbicide uptake longer-term, and fluridone exposure results in chlorophyll degradation in new growth. Therefore, one or more agents could antagonize the activity of the other, but this was not observed in this experiment.

### EXAMPLE 6

### Fluridone+Endothall on Hydrilla−Field Study

### Materials and Methods

A 0.61 acre lake, with an average depth of 6.7 feet in Orange County, Florida was treated on 27 Feb. 2009 with a combination of fluridone and endothall. Endothall (Aquathol K®; 4.23# per gallon dipotassium salt or 3#/gallon a.e.) was applied at 0.71 ppm a.e. (acid equivalence) and fluridone (Sonar A.S.®; 4 #/gallon) at 0.01 ppm. Efficacy was assessed by collecting above ground biomass of hydrilla before and after treatment. Biomass was collected from a spatial area identified before treatment with relatively uniform hydrilla growth. Plants were collected using standardized methods, excess water drained, and fresh weight determined.

### Results

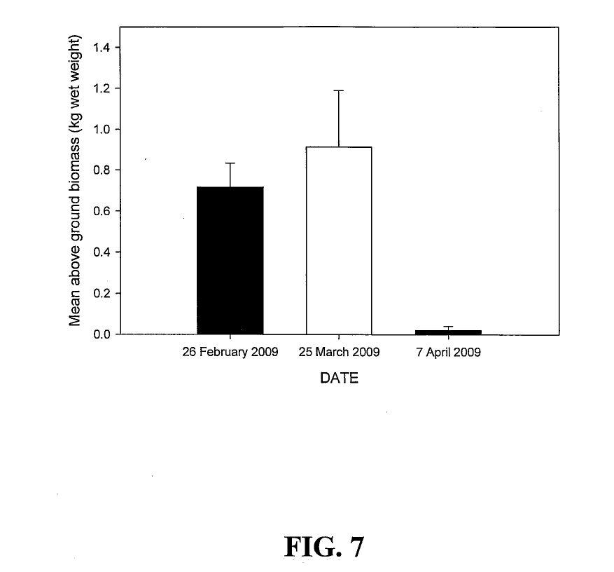

Fluridone plus endothall was very effective at controlling hydrilla. Biomass was reduced by ˜97% by 7^{th} Apr. 2009 (FIG. 7). Unexpectedly these data indicated that in combination a reduced concentration of endothall and a reduced exposure to fluridone can be effective on hydrilla.

Positive interaction between endothall and fluridone was not expected. There was potential for antagonism. Endothall requires shorter exposure than fluridone; endothall is a contact herbicide whereas fluridone is a systemic herbicide. Fluridone is a PDS-inhibitor and needs to be maintained in contact with a target plant for a minimum of 45 days, and under optimum conditions can take 30 to 90 days for control (SePRO Corporation, 2007, Sonar A.S.® Specimen Label, 11550 N. Meridian St., Suite 600, Carmel, Ind. 46032)). Endothall is a relatively rapid acting contact herbicide that requires generally less than 72 hours of contact with hydrilla to achieve effective control (Netherland, M. D., W. R. Green and K. D. Getsinger. 1991. J. Aquatic Plant Manage. 29: 61-67). Endothall is generally applied at approximately 2.1 ppm a.e. to control hydrilla depending on the site (labeled concentrations of 1.4 to 2.8 ppm a.e.) (Cerexagri Inc., 2007, Aquathol K® Specimen Label, 630 Freedom Business Center, Suite 403, King of Prussia, Pa. 19406)). Endothall injures susceptible plants relatively quickly with resultant loss in cell integrity, which could inhibit or preclude effective translocation of a systemic herbicide such as fluridone. However, antagonistic activity was not observed with simultaneous treatment in this experiment, demonstrating that the agents can be effectively used together without inhibiting the activity of either agent.

This new combination of herbicides appears to either produce a synergistic or additive response by providing rapid hydrilla control at significantly reduced rates and/or exposure. This was unexpected and could potentially lead to significant improvements in the effort to control target submersed aquatic plants, such as hydrilla. An additive value of using such a new herbicide mix (two different active ingredients) would be utilizing best management practices for resistance management.

### EXAMPLE 7

### Fluridone+Penoxsulam Selectivity Trials−Greenhouse Trial

### Materials and Methods

Five different native aquatic plants were acquired from a Florida supplier (Aquatic Plants of Florida, Sarasota, Fla.). These species were jointed spikerush (Eleocharis interstincta), spatterdock (Nuphar advena), soft-stem bulrush (Scirpus validus), and maidencane (Panicum hemitomon), and tapegrass (Vallisneria americana). The final native species in the trial—Egyptian panicgrass or Kissimmee ‘Knotgrass’ (Paspalidium geminatum)—and fluridone-resistant hydrilla were collected from West Lake Tohopekaliga (Osceola County, FL). Transplanted tissue for each native species included both young fresh shoot growth and a portion of root stock/rhizome. Hydrilla was planted as 30 cm sections of fresh apical shoot growth. All plants were transplanted into commercial retail topsoil amended with slow-release granular 14-14-14 fertilizer at rate of 2.5 g fertilizer per kg soil. Spatterdock rhizomes were transplanted into 11.4L plastic garden pots, while all other species were transplanted into 1.9-L pots. Soil in each pot was capped with a layer of sand. Single pots of each species were placed in 100-L black polypropylene mesocosm tanks filled with 72 liters of tap water. Tanks were maintained in a greenhouse. Since the study was performed during the winter and early spring, supplemental full spectrum lighting was also utilized to maintain a 14 h:10 h light:dark photoperiod. Both air and water temperature were logged during the study using a Hobo Water Temp Pro V2 Data Loggers (Onset Computer Corporation, Pocasset, Mass.). During study, greenhouse air temperature averaged 26° C. with typical daily fluctuation between 22 C-40 C. Water temperature for one untreated control tank averaged 24° C. with typical daily fluctuation between 22-33° C.

Three weeks after transplanting, herbicide stock solutions were used to apply either fluridone or penoxsulam alone or in combination. Along with an untreated control set, the following theoretical herbicide treatments were applied: 4, 8, 16, and 32 μg L⁻¹ fluridone alone and 4, 8, 16, and 32 μg L⁻¹ penoxsulam alone plus 1:1 combinations of 2+2, 4+4, 8+8, and 16+16 μg L⁻¹ fluridone and penoxsulam. The study utilized a completely randomized treatment design with 6 replicate mesocosms per treatment. Four replicate pots of each species were harvested at time of treatment to quantify pre-treatment aboveground biomass. Herbicide exposures were maintained for 60 days with routine replacement of evaporated water and occasional hand removal of filamentous algal growth. At the end of the 60-day exposure, aboveground biomass of all species were individually harvested. Harvested tissue was dried at 60° C. for 48 hours in a dedicated forced air/heated chamber and weighed using a calibrated Mettler Toledo portable digital balance. Resulting data was analyzed using SigmaPlot 10.0 and SigmaStat 3.5 graphing and statistical analysis software to develop non-linear regression models and resulting 50% effect concentration estimates (EC₅₀) for each species for fluridone or penoxsulam alone or in combination.

### Results

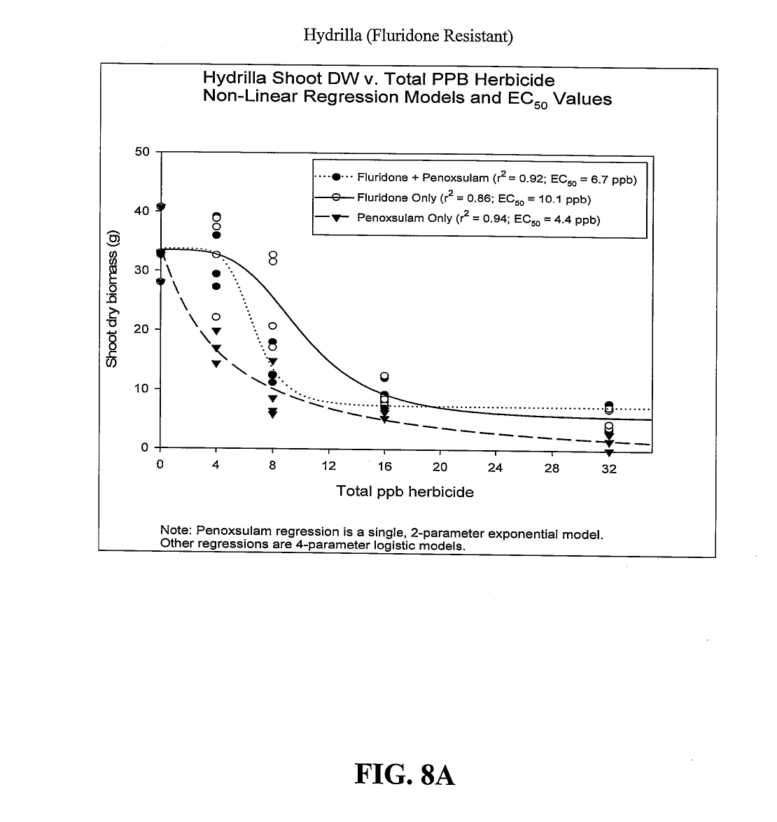

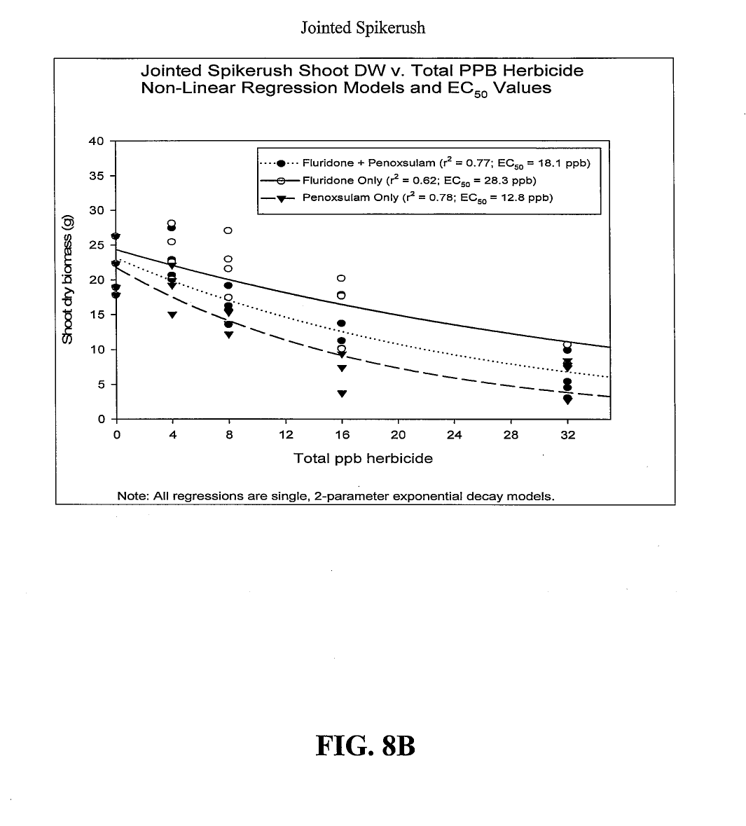

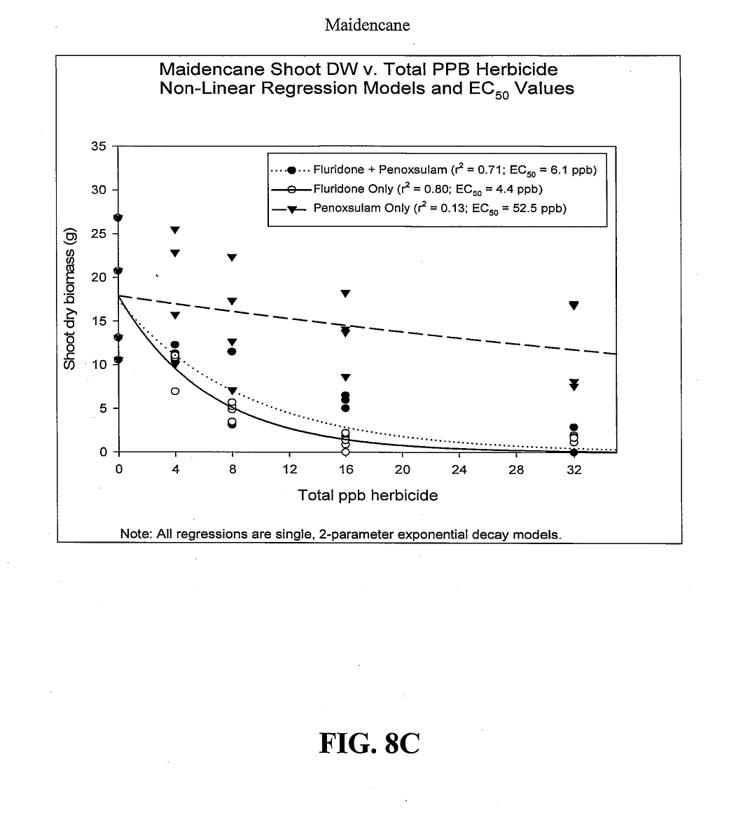

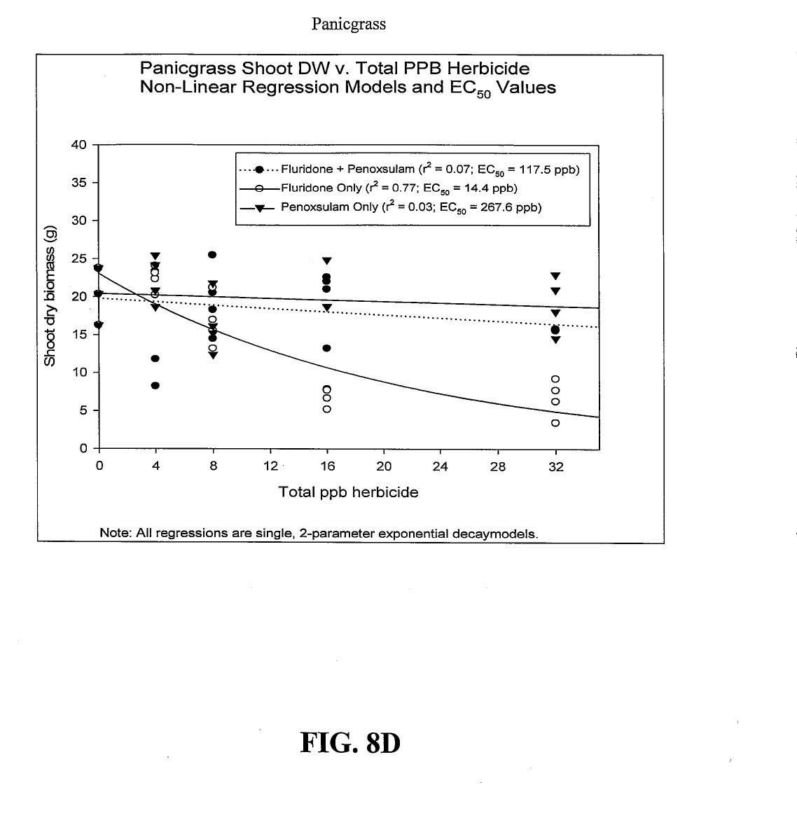

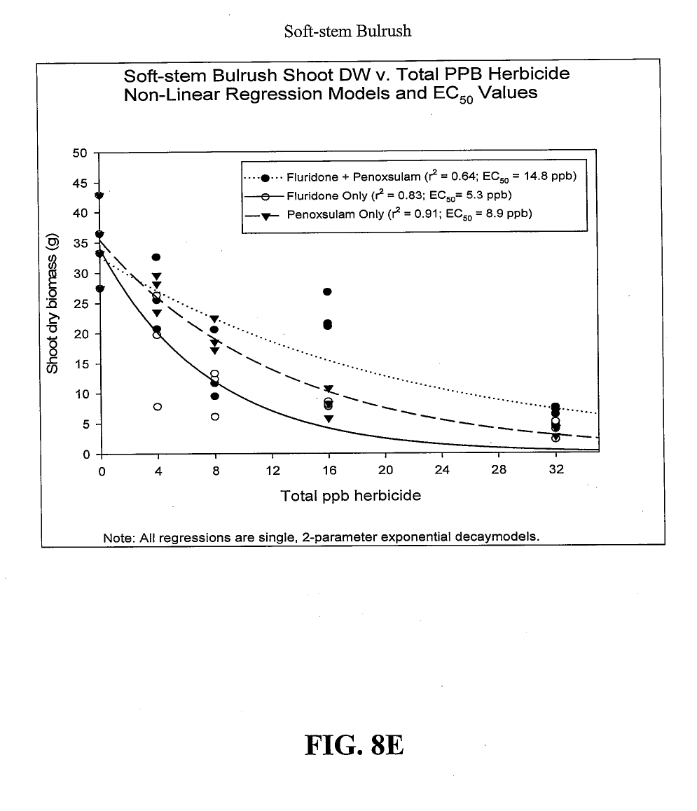

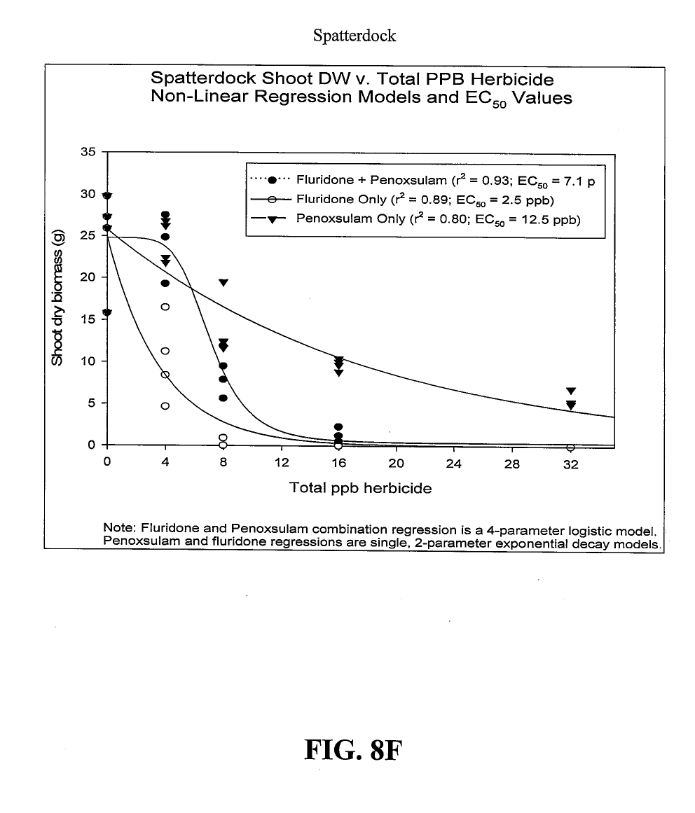

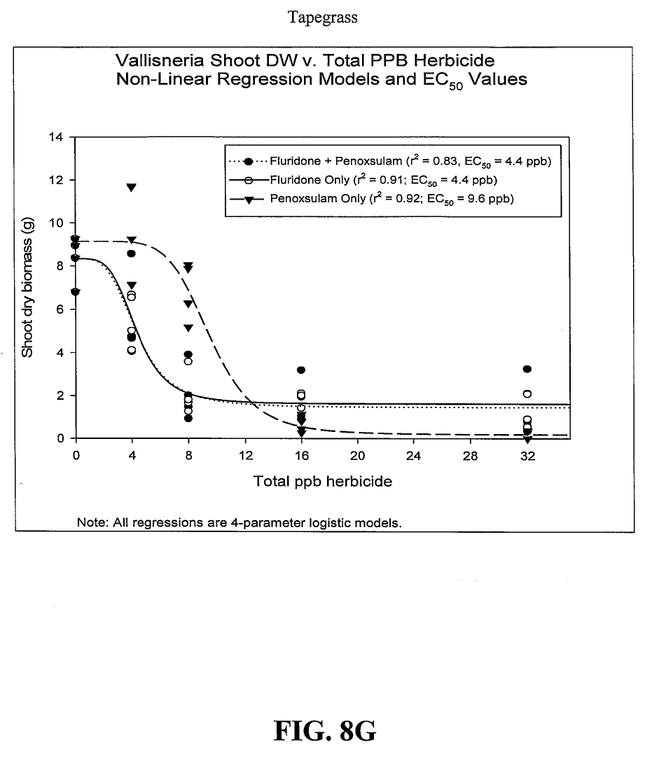

Fluridone and penoxsulam herbicide, alone or in combination, produced significant dose-dependent reductions in aboveground shoot biomass except for penoxsulam alone or fluridone+penoxsulam on panicgrass and penoxsulam alone on maidencane (regression r² values<0.15 and ANOVA p>0.05) (FIG. 8). Calculated EC₅₀ values fell within range of treatment test rates for each herbicide active alone or in combination except for the three herbicide exposures noted here. In a comparative analysis of summarized EC₅₀ values (Table 1), spatterdock was the most sensitive species to fluridone alone (EC₅₀=2.5 ppb) while jointed spikerush was the most fluridone tolerant (EC₅₀=28.3 ppb). Response to fluridone across all species from most to least susceptible was as follows: spafterdock>tapegrass and maidencane>soft-stem bulrush>hydrilla (fluridone-resistant)>panicgrass>jointed spikerush. For penoxsulam alone, panicgrass was the most tolerant species (EC₅₀=267.6 ppb) while the fluridone-resistant strain of hydrilla was the most susceptible (EC₅₀=4.4 ppb). Response to penoxsulam across all species from most to least susceptible was as follows: hydrilla>soft-stem bulrush>tapegrass>spatterdock>jointed spikerush>maidencane>knotgrass. For the 1:1 combination of fluridone+penoxsulam, tapegrass was the most susceptible (EC₅₀=4.4 ppb) and panicgrass was most tolerant (EC₅₀=117.5). Response to fluridone+penoxsulam across all species from most to least susceptible was as follows: tapegrass, maidencane, hydrilla, spatterdock, soft-stem bulrush, jointed spikerush, and panicgrass.

In terms of overall selectivity, the tested fluridone+penoxsulam combination, provided improved selectivity (i.e., higher EC₅₀ values) for four of the six species when compared to fluridone alone (species: maidencane, panicgrass, bulrush, spatterdock), and for two of the six species tested when compared to penoxsulam alone (species: jointed spikerush, bulrush). While penoxsulam alone was the most selective treatment for four of the six species tested in this trial and showed good growth regulation of target hydrilla, penoxsulam alone under operational field use has required very long contact times (greater than 4 months) to achieve full hydrilla control, and such contact times are not feasible for some treatment sites. Particularly for control of more fluridone resistant strains of hydrilla, the ability to use a combination approach may enhance speed of hydrilla control versus penoxsulam alone while improving selectivity versus higher rates of fluridone needed to control resistant biotypes. For example, based on EC₅₀ values in this study, a critically important Florida native plant for fisheries habitat, panicgrass, showed 8 times less sensitivity to fluridone+penoxsulam combination versus fluridone only treatment. Alternate ratios of fluridone and penoxsulam versus the 1:1 ratio used in this trial may also provide additional benefits for overall selectivity with combined herbicide treatment.

TABLE 1
Summary of Calculated EC₅₀ (total parts per billion) for
fluridone + penoxsulam 1:1 combination, fluridone alone, and penoxsulam
alone on shoot biomass of seven aquatic plant species.

| Species | Fluridone:Penoxsulam | Fluridone | Penoxsulam |
|---|---|---|---|
| Hydrilla (FR) | 6.7 | 10.1 | 4.4 |
| Jointed Spikerush | 18.1 | 28.3 | 12.8 |
| Maidencane | 6.1 | 4.4 | 52.5 |
| Panicgrass | 117.5 | 14.4 | 267.6 |
| Soft-stem bulrush | 14.8 | 5.3 | 8.9 |
| Spatterdock | 7.1 | 2.5 | 12.5 |
| Tapegrass | 4.4 | 4.4 | 9.6 |

The uses of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected. In addition, all references cited herein are indicative of the level of skill in the art and are hereby incorporated by reference in their entirety.

What is claimed is:

1. A method for controlling aquatic weeds in a body of water, comprising:
providing in the body of water an herbicidal combination including fluridone and at least one member selected from the group consisting of penoxsulam, bensulfuron-methyl, bispyribac-sodium, and imazamox, so as to control the aquatic weeds.

2. The method of claim 1, wherein the herbicidal combination also includes at least one of triclopyr and 2,4-d.

3. The method of claim 1, wherein the aquatic weeds include hydrilla or Eurasian watermilfoil.

4. The method of claim 1, wherein said herbicidal combination includes fluridone and penoxsulam.

5. The method of claim 1, wherein said herbicidal combination includes fluridone and bensulfuron-methyl.

6. The method of claim 1, wherein said herbicidal combination includes fluridone and bispyribac-sodium.

7. The method of claim 1, wherein said herbicidal combination includes fluridone and imazamox.

8. The method of claim 4, wherein said herbicidal combination also includes triclopyr.

9. The method of claim 4, wherein said herbicidal combination also includes 2,4-d.

10. The method of claim 5, wherein said herbicidal combination also includes triclopyr.

11. The method of claim 5, wherein said herbicidal combination also includes 2,4-d.

12. The method of claim 6, wherein said herbicidal combination also includes triclopyr.

13. The method of claim 6, wherein said herbicidal combination also includes 2,4-d.

14. The method of claim 7, wherein said herbicidal combination also includes triclopyr.

15. The method of claim 7, wherein said herbicidal combination also includes 2,4-d.

16. An herbicidal composition, comprising:
an herbicidal combination including fluridone and at least one member selected from the group consisting of penoxsulam, bensulfuron ethyl, bispyribac sodium, and imazamox.

17. The herbicidal composition of claim 16, wherein the herbicidal combination also includes at least one of triclopyr and 2,4-d.

18. The herbicidal composition of claim 16, wherein said herbicidal combination includes fluridone and penoxsulam.

19. The herbicidal composition of claim 16, wherein said herbicidal combination includes fluridone and bensulfuron-methyl.

20. The herbicidal composition of claim 16, wherein said herbicidal combination includes fluridone and bispyribac-sodium.

21. The herbicidal composition of claim 16, wherein said herbicidal combination includes fluridone and imazamox.

22. The herbicidal composition of claim 18, wherein said herbicidal combination also includes triclopyr.

23. The herbicidal composition of claim 18, wherein said herbicidal combination also includes 2,4-d.

24. The herbicidal composition of claim 19, wherein said herbicidal combination also includes triclopyr.

25. The herbicidal composition of claim 19, wherein said herbicidal combination also includes 2,4-d.

26. The herbicidal composition of claim 20, wherein said herbicidal combination also includes triclopyr.

27. The herbicidal composition of claim 20, wherein said herbicidal combination also includes 2,4-d.

28. The herbicidal composition of claim 21, wherein said herbicidal combination also includes triclopyr.

29. The herbicidal composition of claim 21, wherein said herbicidal combination also includes 2,4-d.

30. A method for controlling aquatic weeds in a body of water, comprising: providing in the body of water an herbicidal combination including fluridone and at least one member selected from the group consisting of carfentrazone, flumioxazin, endothall, copper, diquat, topramezone, or mesotrione so as to control the aquatic weeds.

31. The method of claim 30, wherein the aquatic weeds include hydrilla or Eurasian watermilfoil.

32. The method of claim 30, wherein said herbicidal combination includes fluridone and carfentrazone.

33. The method of claim 30, wherein said herbicidal combination includes fluridone and flumioxazin.

34. The method of claim 30, wherein said herbicidal combination includes fluridone and endothall.

35. The method of claim 30, wherein said herbicidal combination includes fluridone and copper.

36. The method of claim 30, wherein said herbicidal combination includes fluridone and diquat.

37. The method of claim 30, wherein said herbicidal combination includes fluridone and topramezone.

38. The method of claim 30, wherein said herbicidal combination includes fluridone and mesotrione.

39. An herbicidal composition, comprising:
an herbicidal combination including fluridone and at least one member selected from the group consisting of carfentrazone, flumioxazin, endothall, copper, diquat, topramezone, or mesotrione.

40. The herbicidal composition of claim 39, wherein said herbicidal combination includes fluridone and carfentrazone.

41. The herbicidal composition of claim 39, wherein said herbicidal combination includes fluridone and flumioxazin.

42. The herbicidal composition of claim 39, wherein said herbicidal combination includes fluridone and endothall.

43. The herbicidal composition of claim 39, wherein said herbicidal combination includes fluridone and copper.

44. The herbicidal composition of claim 39, wherein said herbicidal combination includes fluridone and diquat.

45. The herbicidal composition of claim 39, wherein said herbicidal combination includes fluridone and topramezone.

46. The herbicidal composition of claim 39, wherein said herbicidal combination includes fluridone and mesotrione

47. A multi-pack herbicide product, comprising:
a first container containing fluridone;
a second container containing at least one member selected from the group consisting of penoxsulam, bensulfuron-methyl, bispyribac-sodium, and imazamox; and a package holding said first container and second container.
